(19) United States
(12) Patent Application Publication
(10) Pub. No.: US 2003/0083844 A1
(43) Pub. Date: May 1, 2003

(54) Optical position sensing of multiple radiating sources in a movable body

(76) Inventors: M. Mahadeva Reddi, Bryn Mawr, PA (US); Mitchell B. Oslon, Collegeville, PA (US); Dennis A. Silage, Newtown Square, PA (US)

Correspondence Address: Jonathan M. Waldman, Esq., WOODCOCK WASHBURN KURTZ, MACKIEWICZ & NORRIS LLP, One Liberty Place - 46th Floor, Philadelphia, PA, 19103, US

(21) Appl. No.: 10/020,479

(22) Filed: Oct. 30, 2001

(51) Int. Cl. G06F 15/00

(52) U.S. Cl. 702/150

(57) ABSTRACT

A non-contact sensing system for synchronous monitoring of the three-dimensional positions of multiple radiating sources in a crash test dummy comprises three linear sensors, each comprising a cylindrical lens and a linear array of photosensitive elements. Sources and corresponding images on the linear array are associated. The angular measurements from the three linear sensors are used for triangulation of the positions of the sources. In another embodiment, a tri-linear array of photosensitive elements with red, green and blue filters are used with sources radiating red, green and blue light to result in chromatic identification and six-degrees-of-freedom position measurement.

### GOVERNMENT INTERESTS

The U.S. may have certain rights in this invention pursuant to Contract No. DTNH22-97-D-07012.

### FIELD OF THE INVENTION

The present invention relates in general to systems and methods for position sensing. More particularly, the present invention relates to measuring the three-dimensional positions of locations of interest on the surfaces of movable bodies.

### BACKGROUND OF THE INVENTION

The three-dimensional positions of selected points on a given body, especially after onset of motion, are of interest in many areas of endeavor. Such positional time history is useful for computer animation, gait analysis, ergonomics, and other applications in medicine, engineering, entertainment, and defense, to name a few.

The orientation of an axis that is affixed to a surface is also of interest in many applications. Helmet mounted systems used in combat aircraft, for example, often include means for pointing weapons or other systems based on the pilot's line of sight determined indirectly from measurement of the orientation of the helmet.

In the automobile industry, the deformation history of vehicular structures in a crash environment enables development of crashworthy vehicles. For example, intrusion of the floor pan into the passenger compartment can be injurious to the lower extremities of a passenger. A means for measuring such intrusion is useful for designing more crashworthy vehicles. Further, effectiveness of new designs is judged from the dynamic response of crash test dummies. Amongst the several parameters that comprise dynamic response, thoracic deformations are of major significance in assessing injury severity. The widely used injury criteria, chest deflection and viscous response, are derived from position measurements. Thus, a means for measuring the position history of surfaces in vehicles and the position history of dummies is of considerable utility to the automobile industry and the driving public.

Some of the shortcomings of the existing systems arise from the fact that they are contact systems (electromechanical), requiring a physical connection of the two points between which measurements are made. This physical connection is constrained by the requirement that the act of measuring does not adversely effect the measurement itself String potentiometers that are commonly used in existing systems impose unwanted spring forces and inertia loading on the chest wall. Also, while the transient response of a string potentiometer improves with increasing stiffness of its retracting spring, the unwanted spring force on the chest wall also increases. Consequently, measuring fast transients with string potentiometers involves some form of tradeoff in the response. This is particularly acute in situations when the chest wall begins to move rapidly, as for example, after contact with a deploying airbag. The response for such fast transients has been found to be unacceptably poor. Further, the signal to noise ratio of electrical signals developed from a potentiometer generally degrades with use because of mechanical wear. Additionally, mechanical systems suffer from dead zones, play and backlash in the linkages.

Two principal criteria for assessing potential injury levels are the chest deflection and the viscous response, the latter being the numerical product of deflection and the velocity with which the deflection occurs when a test dummy is in a crash environment. From position measurements, deflection of the chest wall can be readily obtained, but finding its velocity requires differentiation of the positional time history signal. Any noise in the signal, including those due to artifacts arising from mechanical play, stick-slip or backlash, will significantly reduce the usefulness of the velocity history obtained by differentiation. Filtering of the signal has not been found to improve the results.

To obviate these shortcomings, a non-contact optical position sensing system has been proposed. Though expensive, position sensing detectors are capable of high sampling rates. However, they can measure only a single target at a time. The process of activating and deactivating each target sequentially, termed “multiplexing”, allows measurement of a plurality of targets, but the effective sampling rate is reduced by a factor equal to the number of targets being measured. Another disadvantage of optical position sensing detectors is that reflected or scattered light from the targets and the environment can lead to significant measurement errors caused by a shift in the centroid of the target's image spot on the detector. Still another disadvantage is that non-linearity in the response increases as the light spot moves from the center to the outer edges of the detector.

Charge coupled devices, called “CCDs”, in their two-dimensional array version can be used in place of optical position sensing detectors to result in a system that is not limited to imaging a single target at a time. Such systems are widely used for direction measurements of passive targets formed of retro-reflective material or active targets such as light emitting diodes. High contrast targets may also be digitized directly from the video signal, or each frame may be digitized by using a frame grabber. However, the amount of raw data that is produced is quite considerable, even if only a selected portion of the frame is digitized. Further, the low resolution and the slow frame rate of a standard video system make it unsuitable for most measurement applications. Nonstandard video systems, with faster frame rates and better resolution, on the other hand, are unacceptably high in cost for most applications.

To overcome the limitations of two-dimensional CCD arrays, several prior art position or direction measuring devices incorporate one-dimensional CCD arrays, hereafter called linear CCDs. Typically, a linear CCD comprises a linear array of discrete photosensitive elements with high resolution and fast framing rates. A linear CCD together with a cylindrical lens, called a “linear sensor”, forms a basic building block. A cylindrical lens has the property that it images a point source as a line at the intersection of its focal plane with a plane passing through the lens axis (axis of the cylinder) and the point source. In lieu of the lens, an aperture mask with a slit collinear with the lens axis will produce substantially the same result, but with considerably less image brightness for equal image sharpness. Other optical arrangements to produce a line image of a point source are available, but the cylindrical lens is preferred for the purpose. The axis of the linear CCD is oriented at an angle, generally 90°, to the lens axis. In operation, a linear sensor's photosensitive cells can be examined to determine the location of the line image projected by a target and thereby establish the plane passing through both the target and the lens axis.

FIG. 1 illustrates a prior art linear sensor that can determine the plane 10 passing through the lens axis 11 of a cylindrical lens 12 and a radiating target 13. The cylindrical lens 12 forms a line image 14 of the target 13 on an image plane containing a linear CCD sensor 15. The CCD 15 has an elongated light sensitive region 16 along a longitudinal axis 17, the axis 17 being oriented perpendicularly to the lens axis 11. The CCD 15 provides an electrical signal 9 indicating the position x₁ of the line image 14 with respect to an origin on axis 17. The lens axis 11 and the position of the line image 14 on the longitudinal axis 17 of the sensor define the plane 10 containing the target 13. The field of view FOV of the linear sensor is the angle subtended by a first plane passing through the lens axis 11 and a first end of the light sensitive region 16 and a second plane passing through the lens axis 11 and a second end of the light sensitive region 16.

An assembly of two linear sensors, mounted such that their lens axes are nonparallel, can measure the direction to a single target. Each linear sensor then defines a plane passing through its lens axis and the target. The intersection of the two planes forms a line of direction from the assembly to the target. (The direction to a single target can also be measured by means of only one linear CCD when it is combined with an aperture mask comprising two mutually inclined slits). However, if N targets are imaged during a single exposure, then N×N plane intersections result and identification of the desired intersections and the corresponding targets requires multiplexing or other means.

U.S. Pat. No. 4,973,156, issued to Dainis, describes a prior art assembly in which three linear sensors together comprise a device for simultaneously measuring the directions of a plurality of optical targets. The additional linear sensor resolves the ambiguity posed by multiple targets, but also adds an additional data channel. Moreover, the computational effort is significantly increased, because 2×N×N intersections have to be determined, and compared, to identify the true locations of the given N targets. This computational burden makes the device unattractive, particularly for real-time processing.

For measuring the position of a single target, a prior art embodiment uses three linear sensors as shown in FIG. 2a. Referring to FIG. 2a, the three linear sensors, labeled A, B and C, are mounted in separate locations on a common plane surface of an elongated structure 42 such as a bar. The end linear sensors A and B are mounted with their lens axes 43A and 43B oriented vertically and measure angles to a target in the horizontal plane, whereas the central linear sensor C has its lens axis 43C oriented horizontally to measure the angle to the target in a vertical plane. Each end sensor defines a plane containing the target and the two planes intersect in a vertical line whose intersection with the plane defined by the central sensor determines the location of the target. The distance L between the lens axes 43A and 43B is termed “base length”. The accuracy of position measurement is directly proportional to the base length L and inversely related to the field of view of the linear sensors. A typical prior art base length is about 12 inches, and targets are typically disposed about several feet from the sensor.

With the sensor of FIG. 2a, if there are N targets, then the N planes from each end sensor intersect in N×N vertical lines and the N planes from the central sensor intersect the vertical lines to result in a total of N×N×N intersections. Thus, identification of the desired intersections and the corresponding targets requires multiplexing or other means.

Despite effort by practitioners of the art, a need exists for a low cost technique and device capable of making high speed, high resolution, synchronous, and accurate position measurements of a plurality of points, particularly for use in connection with crash test dummies.

### SUMMARY OF THE INVENTION

The present invention is directed to position sensing systems and methods that the resolve the ambiguity posed by multiple targets (radiation sources) and comprises techniques based on predictive tracking of each image in each linear sensor of a plurality of linear sensors. For clustered targets, as may be needed for measuring the orientation of axes such as surface normals and tangents, multi-chromatic targets and multi-chromatic linear CCD sensors are also provided.

An embodiment of the invention is directed to a position sensor for locating multiple radiating sources, comprising first, second and third linear sensors. Each linear sensor comprises: an optical device that focuses a source of radiation to form a line image parallel to a longitudinal optical axis of the optical device; and an elongated light sensitive area positioned in a focal plane of the optical device for developing signals responsive to the radiation. The light sensitive area comprises at least one linear array of photosensitive elements parallel to an axis that is aligned substantially orthogonal to the longitudinal optical axis of the optical device. The first, second and third linear sensors each have the light sensitive area arranged in a plane, the axes of the light sensitive areas of the first and second sensors are aligned in a first direction and the axis of the light sensitive area of the third sensor is oriented in a second direction orthogonal to the first direction and disposed between the first and second linear sensors. The position sensor further comprises a computational device coupled to the linear sensors; a mass storage device coupled to the computational device; and a display device coupled to the computational device.

According to aspects of the invention, each light sensitive area comprises: a first array overlayed with a first optical filter for transmitting light in a first spectral band; a second array overlayed with a second optical filter for transmitting light in a second spectral band; and a third array overlayed with a third optical filter for transmitting light in a third spectral band such that the first, second, and third arrays develop signals responsive to radiation emitted by sources radiating light in the first, second and third spectral bands, respectively. For example, the first spectral band corresponds to red, the second spectral band corresponds to green, and the third spectral band corresponds to blue.

According to further aspects of the invention, the computational device is adapted to (a) turn radiation sources on and off; (b) determine an image peak position of a radiation source in a video frame for each of a plurality of radiation sources and linear sensors; (c) store image peak positions in a storage device; (d) generate an association table for relating each of the plurality of radiation sources with their respective image peak positions; (e) set a gate width for searching for a radiation source-associated-peak in a subsequent video frame, predicting an expected position value for the radiation source-associated-peak in the subsequent video frame, and searching for the radiation source-associated-peak in the subsequent video frame responsive to the gate width and the expected position; and (f) determine positions of radiation sources.

Another embodiment of the invention is directed to a method of operating a position sensor in a slow mode, comprising: for each of a plurality of radiation sources, in sequence (a) turning on a radiation source; (b) determining an image peak position of the radiation source in a video frame for each of a plurality of linear sensors; (c) storing the image peak positions in a storage device; (d) turning the radiation source off; (e) generating an association table for relating each of the plurality of radiation sources with associated image peak positions; (f) determining the radiation source positions based on the association table; and (g) repeating steps (a) through (f) for a predetermined time duration.

Another embodiment of the invention is directed to a method of operating a position sensor in a fast mode, comprising: for each of a plurality of radiation sources, in sequence (a) turning on a radiation source; (b) determining an image peak position of the radiation source in a video frame for each of a plurality of linear sensors; (c) storing the image peak positions in a storage device; and (d) turning the radiation source off; generating an association table for relating each of the plurality of radiation source with an associated image peak position; and turning on all of the plurality of radiation sources.

Another embodiment of the invention is directed- to a crash test dummy comprising a wide-field position sensor attached to the crash test dummy and a plurality of optical targets disposed on the crash test dummy at respective locations for measurement by the wide-field position sensor.

The foregoing and other aspects of the present invention will become apparent from the following detailed description of the invention when considered in conjunction with the accompanying drawings.

### BRIEF DESCRIPTION OF THE DRAWINGS

FIG. 1 (prior art) is a simplified diagram of a conventional linear sensor;

FIG. 2a (prior art) is a structural diagram of linear sensors arranged to form a conventional position sensor for single targets;

FIG. 2b is a structural diagram of linear sensors arranged to form an exemplary position sensor for single targets in accordance with the present invention;

FIG. 3a (prior art) is a diagram of the field of view of a conventional position sensor;

FIG. 3b is a diagram of the field of view of an exemplary wide-field position sensor in accordance with the present invention;

FIG. 4a (prior art) is a diagram of the output of a typical linear CCD with two images;

FIG. 4b is a diagram of the output of frame i of a linear CCD with several targets that is helpful in explaining the present invention;

FIG. 4c is a diagram of the output of frame i+1 of a linear CCD with several targets that is helpful in explaining the present invention;

FIG. 5 shows a cross-section of the thorax of an exemplary crash test dummy with an exemplary wide-field position sensor and targets in accordance with the present invention;

FIG. 6 is a structural diagram of an exemplary wide-field position sensor in accordance with the present invention;

FIG. 7 is a flowchart of an exemplary process for identification and association of targets with corresponding images in a linear CCD video frame in accordance with the present invention;

FIG. 8 is a structural diagram of an exemplary RGB linear sensor in accordance with the present invention; and

FIG. 9 is a structural diagram of an exemplary RGB wide-field position sensor in accordance with the present invention.

### DETAILED DESCRIPTION

The present invention is directed to resolving the ambiguity posed by multiple targets and comprises techniques based on predictive tracking of each image in each linear sensor of a plurality of linear sensors. For clustered targets, as may be needed for measuring the orientation of axes such as surface normals and tangents, multi-chromatic targets and multi-chromatic linear CCD sensors are also provided.

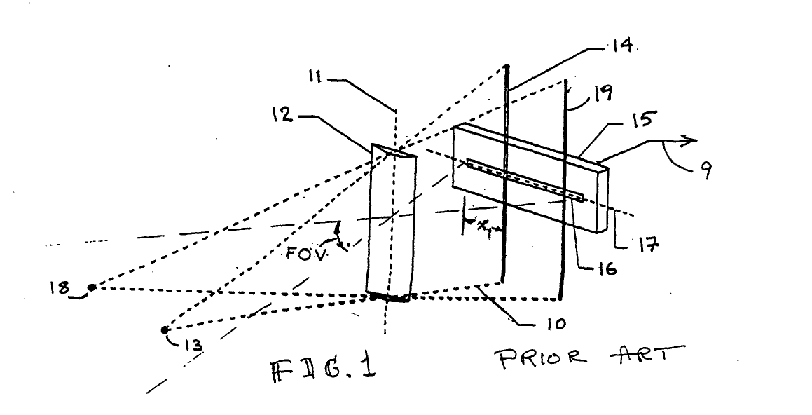

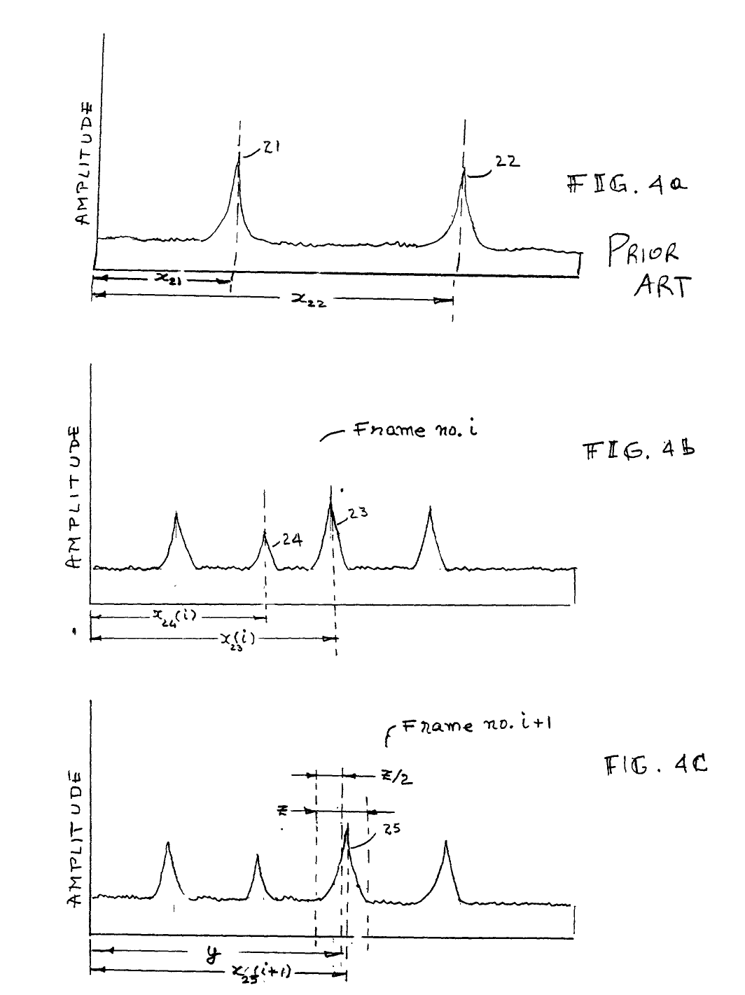

Referring again to FIG. 1, targets 13 and 18 produce line images 14 and 19, respectively. The corresponding output from a typical linear CCD, framed by one scan of the light sensitive area 16 of the CCD 15, is shown in FIG. 4a. The frame shows signal amplitude indicative of the intensity of light incident on the light sensitive area 16 as a function of the distance along the longitudinal axis 17. The peaks in signal amplitude 21 and 22 result from the line images 14 and 19, respectively, of the targets. The distances x₂₁ and x₂₂, generally in units of number of pixels, of the peaks usually from one end of the light sensitive area 16, together with similar information from other linear sensors, enables either direction finding or triangulation for position of each target.

For an exemplary case with several targets, FIG. 4b depicts corresponding peaks in a frame numbered i, in a sequence of frames obtained during a measurement. Suppose that in frame no. i, the association between peaks and corresponding targets is known together with other kinematic information such as rates of change of peak positions, amplitudes, etc. In the next frame no. i+1, the ambiguity that arises is which peak is associated with which target.

In accordance with the present invention, the ambiguity is resolved by employing predictive tracking techniques. In frame no. i, suppose that peak 23 is known to be associated with a specific target and that the position of peak 23 is x₂₃(i), and the rate of change of its position per frame is v₂₃(i) where i is the frame number. A predictor for the expected position y of the peak associated with the target in the next frame no. i+1 is in the form of y=x₂₃(i)+v₂₃(i). To narrow the search about the expected position y, a peak 24 which is the nearest neighbor to peak 23 is identified and a gate width z is found from z=α|x₂₃−x₂₄|, where α is an arbitrary factor that is positive in sign but less than or equal to one in value. Preferably, α=1, but may be reduced if a previous search was successful within a smaller gate width.

In frame no. i+1, depicted in FIG. 4c, a search for a peak 25 in a gate width z centered about y finds the actual peak position x₂₅(i+1) associated with the target in frame no. i+1. Thus, prior to commencing measurement, if each target is sequentially activated and deactivated and the position of its image peak recorded, then during or after measurement, the images can be identified and associated with targets by tracking. It should be noted that the target tracking and association described in the foregoing is in the image space comprising the set of synchronous video frames from the linear sensors. Such tracking may be done by determining the expected value in the physical space of the targets and projecting to the image space as disclosed in U.S. Pat. No. 5,828,770, incorporated herein by reference, but will entail a substantial computational burden.

In one aspect of the present invention, a system is described for determining directions to multiple targets, comprising two linear sensors, each with a cylindrical optic system for focusing light on a linear array of photosensitive elements whereby the orientation of each plane containing the cylinder axis of the lens and each target is recorded. Two such linear sensors mounted with their cylinder axis perpendicular to each other simultaneously measure the directions of a plurality of optical targets with sampling rates and resolution considerably superior to those provided by multiplexing methods, or standard video technology. In devices based on using just two linear sensors, the direction of a single target is given by the intersection of two planes, each defined by a cylinder axis and the target. If a plurality of targets is sensed, more plane intersections than targets are produced. The ambiguity is resolved by recording initial positions of each target image on the linear array of photosensitive elements, and thereafter, identifying and associating images with respective targets by using predictive tracking methodologies.

In another aspect of the present invention, a system is described for determining the three-dimensional positions of multiple targets, comprising three linear sensors mounted on a common surface of a bar with one sensor mounted at each end and another mounted at its center. The end linear sensors are arranged with their axes oriented vertically, and the middle sensor with its axis oriented horizontally. The three-dimensional positions of multiple targets can be measured by initially recording the image positions of each target image on the linear array of photosensitive elements, and thereafter, identifying and associating images with respective targets by using predictive tracking methodologies.

The foregoing aspects of the invention can be used in a variety of embodiments, several of which are described herein.

Position Measurement in Crash Test Dummies

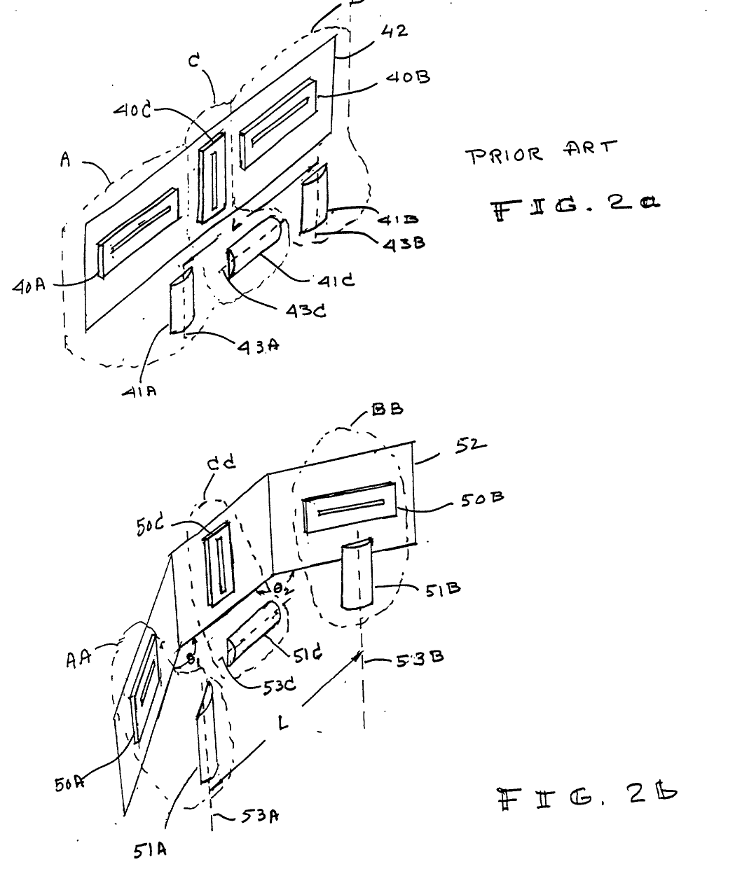

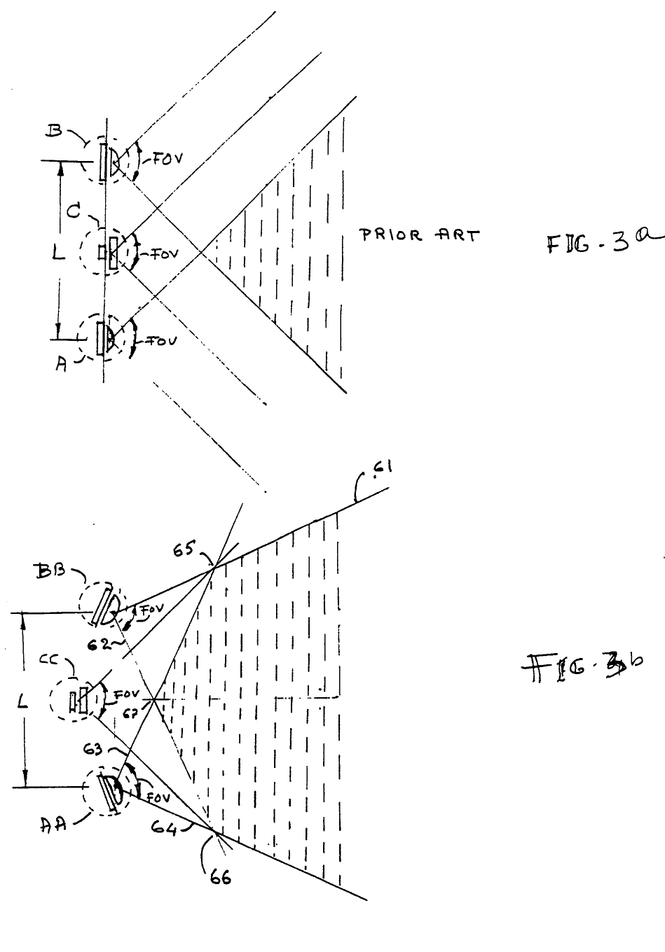

With the sensor arrangement in FIG. 2a, the spatial envelope in which targets can be sensed is the space common to the field of view of all three linear sensors. Referring to FIG. 3a, this space is shown as a hatched area comprising the intersection of the fields of view of all three linear sensors A, B and C. Targets in much of the space adjacent to the linear sensors lie outside this intersection and hence cannot be sensed. Increasing the base length L for improved measurement accuracy increases the unavailable space further. Thus, the sensor arrangement of FIG. 2a is not desirable for sensing targets that are in close proximity, as would be the case with measurements in the thorax of a crash test dummy.

In accordance with the invention, to enable sensing of targets in close proximity to the sensor, two end linear sensors AA and BB shown in FIG. 2b are arranged to be non-coplanar and pointed inwards toward the field of view of a linear sensor CC positioned in the middle, all three being mounted on a support 52. The angles θ₁ and θ₂ between linear sensors AA and CC, and BB and CC, respectively, can each be any desired angle. Preferably θ₁=θ₂. For a target between about 3 and about 6 inches away, it is desirable that θ₁ and θ₂=about 165°, for a FOV (see FIG. 3b) of about 80°. Similarly, for a FOV of about 90 degrees, θ₁ and θ₂ preferably equal about 162°.

Cylindrical lenses 51A and 51B are mounted with their respective lens axes 53A and 53B of lenses oriented vertically and measure angles to a target in the horizontal plane, whereas the central linear sensor has its lens 51C with its lens axis 53C oriented horizontally to measure the angle to the target in a vertical plane. Each end sensor defines a plane containing the target and the two planes intersect in a vertical line whose intersection with the plane defined by the central sensor determines the location of the target. The distance L between the lens axes 53A and 53B is the base length, and for a target between about 3 and about 6 inches away, L preferably equals about 1.5 to about 2 inches.

As shown in FIG. 3b, the field of view of linear sensor BB is defined by planes 61 and 62 passing through its lens axis, and the field of view of linear sensor AA is defined by planes 63 and 64 passing through its lens axis. Planes 61 and 63 intersect on line 65, and planes 62 and 64 intersect on line 66. Also, planes 62 and 63 intersect on line 67. Linear sensor CC is positioned in such a way that its field of view includes lines 65 and 66. All targets located in the spatial envelope shown hatched in FIG. 3b and defined by plane 61 from infinity to line 65, plane 64 from infinity to line 66, plane 62 between lines 66 and 67, and plane 63 between lines 65 and 67, can be sensed for measurement. Comparing the hatched areas in FIGS. 3a and 3b, it is apparent that for a given base length L, and given field of view FOV of the linear sensors, not only can targets be sensed in a bigger space envelope in accordance with the present invention, but the targets can also be in closer proximity to the disclosed linear sensor arrangement. This arrangement of linear sensors, as shown in FIGS. 2b and 3b is referred to as the wide-field position sensor.

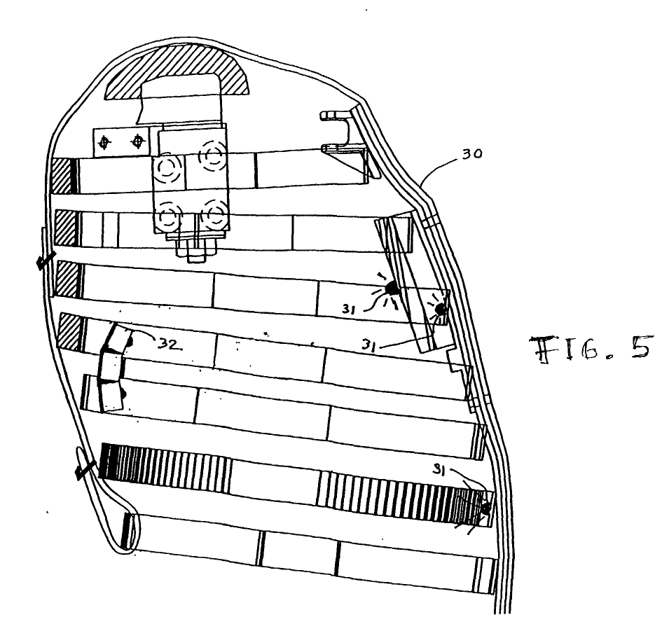

An exemplary embodiment of the invention for position measurement of targets in a crash test dummy is described with respect to FIG. 5. A vertical section of a thoracic assembly 30 of a crash test dummy is shown with a wide-field position sensor 32 affixed to the vertebral column (not shown) at the rear of the thorax. Optical targets 31 are affixed to the interior surface of the front of the thorax at desired locations. Several such sensors and targets might be placed at various locations in the thoracic cavity for position measurements in selected areas.

Under crash loads, a thoracic wall undergoes displacement as well as rotation. As a result, any radiating source attached to the wall also undergoes displacement and rotation. If the source radiates only a narrow beam, then during measurement the beam may be rotated to such an extent that it no longer impinges on the linear sensors, and hence cannot be sensed. Thus, the targets 31 preferably cast radiation with a view angle sufficient for the intended purpose. For example, readily available LED's have view angles up to 140°. To increase this angle further, small pyramidal clusters of miniature surface mount type LED's, such as Lumex SML-LX0603SRW-TR, may be used as targets, among others.

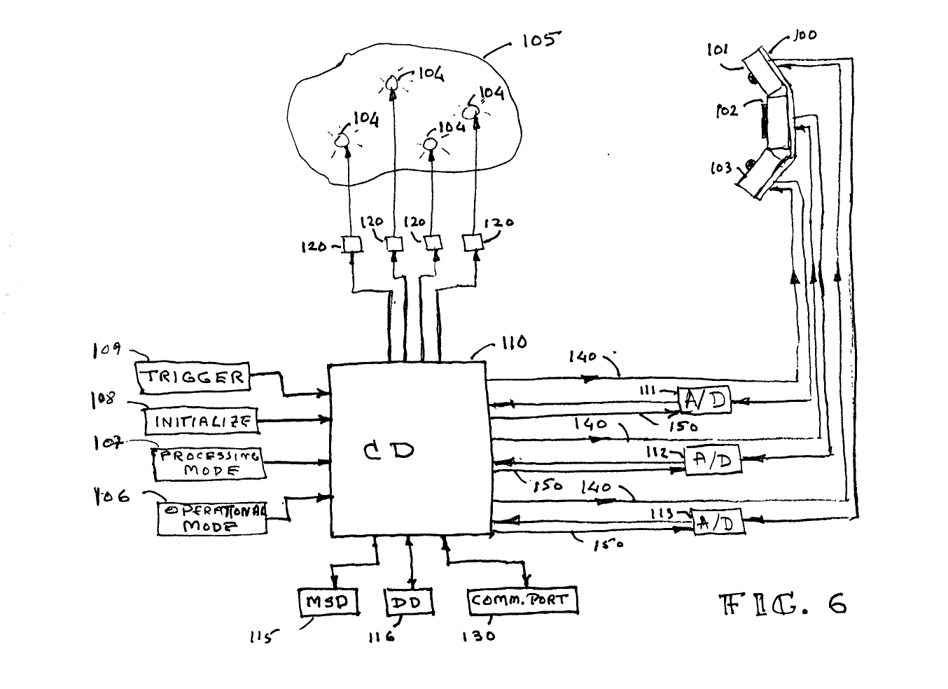

FIG. 6 is a structural diagram of an exemplary wide-field position sensor in accordance with the present invention. A wide-field position sensor 100 comprises three linear sensors 101, 102, and 103. Targets 104 are disposed at selected points of surface 105. An exemplary computational device (CD) 110 comprises a sequential instruction algorithmic machine or a microprocessor. Other embodiments of the computational device may include, for example, programmable logic, dataflow, or systolic array algorithmic machines, etc.

Externally derived control signals for the CD 110 include an operational mode signal 106 for operating in either a slow-speed mode for applications in which only slow sampling rates is desired, or a high-speed mode for applications in which synchronous sampling of all targets is desired; a processing mode signal 107 for setting real-time or post processing of data; an initialization signal 108 desired when the high-speed mode is selected; and a trigger signal 109 for starting the measurement process. It is noted that slow-speed is considered to be less than about 1000 frames/second, and high-speed is considered to be at least about 1000 frames/second.

The CD 110 provides a clock signal 140 to each of the linear sensors to scan the light sensing area of its CCD and return a frame of video data. The CD 110 also provides a clock signal 150 to each of the AID converters 111, 112 and 113 to acquire and digitize the analog video outputs of the linear sensors 101, 102 and 103, respectively. The digital video outputs from the A/D converters 111, 112 and 113, in turn, become inputs to the CD 110.

The CD 110 also controls power-switching circuits 120 for the targets 104 such that each target can be individually activated or deactivated.

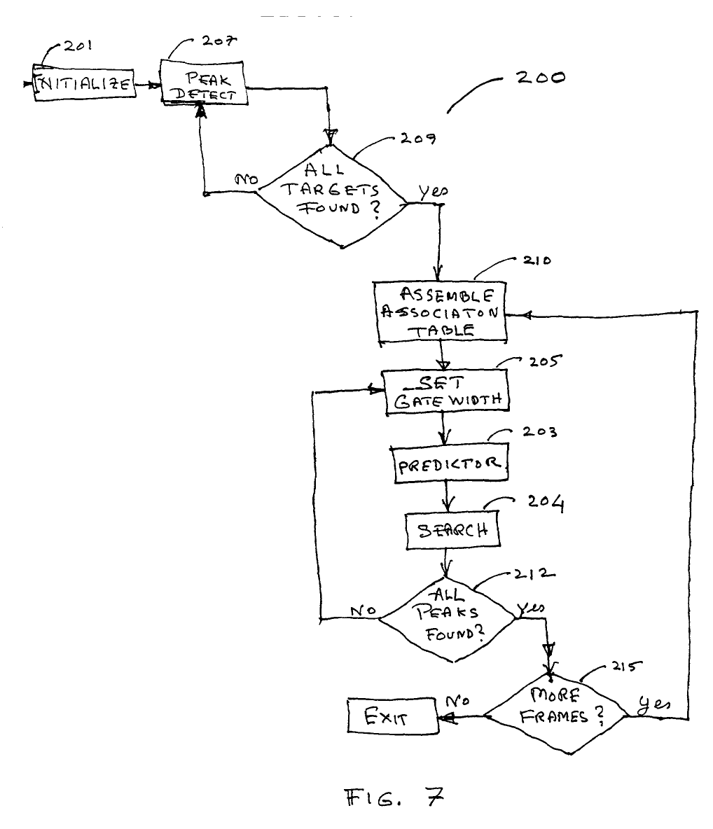

As described subsequently, if high-speed operation is set by the externally derived control signals, the CD 110 may also execute the process 200, described with respect to FIG. 7.

A mass storage device (MSD) 115, such as a random access memory (RAM) or magnetic or optical storage device or other memory device, records the raw data and real-time processed data as desired. A display device (DD) 116 shows a graphical or textual rendering of the raw CCD video frames from the linear sensors 101, 102 and 103, as well as position history of the targets 104. A communication port 130 enables uploading of data specific to the test, such as the number of targets, test duration after triggering, etc. to the CD 110, and downloading of test results to an external computer (not shown).

In a slow-speed mode of operation, when a trigger control signal 109 is received for commencing measurement, the CD 110 activates a first target, and sends a clock signal to each of the linear sensors to output a video frame. A clock signal to the A/D converters enables digitization and the digital video frame is then stored in the MSD 115. If real-time processing is desired, the position of the target is determined and stored in the MSD 115. The CD 110 repeats the process until all the remaining targets are similarly acquired. It then reactivates the first target and continues the process until the preset time duration for measurement has elapsed.

In a high-speed mode of operation, when an initialize control signal 108 is received, the CD 110 activates and deactivates each target separately to establish the position of each target image in the digital video frames of each linear sensor for use in the subsequent identification. Next, prior to commencing measurement, the CD 110 activates all the targets. Then, when a trigger control signal 109 is received, the CD 110 sends a clock signal to each of the linear sensors to output a video frame. A clock signal to the A/D converters enables digitization and the digital video frame is then stored in the MSD 115. If the processing mode control signal 107 is set for real-time processing, the CD 110 executes the process 200 in FIG. 7 for the identification, association, and predictive tracking of the plurality of target images. The CD 110 also determines the target positions. The processed data is stored in the MSD 115. The CD 110 repeats the process until the preset time duration for measurement has elapsed. If the processing mode control signal is set for post processing, the CD 110 stores only the raw video frame data in the MSD 115. The data may then be processed at a convenient time by activating the process 200.

FIG. 7 shows a flowchart of an exemplary process 200 for the association of images with targets in the image space of each frame using algorithmic identification and predictive tracking in accordance with the present invention. The process is exercised for each linear sensor.

At step 201, each image peak position in each video frame is initially associated with its target. Because the CD activates and deactivates each of the N targets, one at a time, and acquires a digital video frame from each of the linear sensors, there will be N frames, each with a single image, for each linear sensor. The next step 207 finds the position of the image peak, utilizing peak-search techniques that are well known in the art of computer programming. A peak may be the position of maximum amplitude, but more robust results are obtained by using the ideas of a centroid, or curve fitting. Step 209 repeats the peak detect process until the peaks for the N targets have been found.

An association table for relating targets and positions of their peaks is then assembled at step 210 for the linear sensor. The purpose of the table is that if all the targets are activated, then it provides the association between targets and peak positions in the digital video frame of its corresponding linear sensor. The table also comprises additional information relating to peak amplitudes, and rates of change of positions and amplitudes. Rate information, such as rate of change per frame of peak position, amplitude, etc. are all initially set to zero.

Step 205 sets a gate width for searching for each target-associated-peak in the next frame. In a preferred form, it is set equal to the distance of the nearest neighbor of each peak in the current frame. The search in the next frame for locating the peak is confined to the span of the gate width centered about the current peak position. Other methods for setting the gate width include use of rate information to reduce its size.

Using the association table assembled from the previous frame, at step 203, a predictor provides an expected position value for the peak using its previous position value plus its expected change on the basis of rate of change of position per frame.

At step 204, a search procedure centered about the expected value within the gate width is made to identify the peak that is the closest neighbor of the expected position. A loop process 212 repeats the steps 205, 203 and 204 until all the peaks have been identified and associated with their targets. Then the loop process 215 starts step 210 to update the association table to reflect the new values and continues the processing until all the frames are processed.

Thus, a system is provided for measuring the three-dimensional positions of multiple targets when targets are in close proximity to the means for measurement, as is the case within the thorax of a crash test dummy. The system comprises three linear sensors mounted on a bar with two bends such that the vertical end plane surfaces preferably make equal angles with the middle, vertical plane surface. The end linear sensors are arranged with their axes oriented vertically, and the middle sensor with its axis oriented horizontally. The spatial envelope is the intersection of the field of view of all three linear sensors and is considerably larger than with the arrangements practiced in the prior art.

The present embodiment is preferably for the measurement of target positions on the interior surface of the thorax of a crash test dummy, but, as will be recognized by those skilled in the art, it is not limited to the specific embodiments discussed herein. In particular, it should be noted that directions to multiple targets could be readily determined in accordance with the present invention by eliminating one of the linear sensors 101 or 103 shown in FIG. 6, as described herein.

Measurement of Six Degrees of Freedom Motion

Frequently, it is desirable to know not only the position, but also the angular orientation of axes affixed to a surface at a selected point of the surface. This involves determining three positional and three angular coordinates at the point, commonly termed measuring motion in six degrees of freedom, hereafter called 6-DOF. Such measurements, for example, are particularly useful in wind tunnel testing of aircraft wings and control surfaces.

Conventionally, tri-linear CCD's are available with three closely spaced, parallel, elongated light sensitive areas with three optical filters in one package. Each filter has a different pass band, generally corresponding with one of the red, blue or green spectral frequencies, as typified by the Kodak KLI-6003, tri-linear CCD. If red, blue and green LED's are used as targets, then an image peak for the red target appears only in the signal from that elongated light sensitive area that is equipped with the red filter. Similarly, the green or blue targets produce a peak only in the signal from the corresponding green or blue filtered light sensitive area. Thus, a closely clustered triplet of red, green and blue targets will produce only a single peak in each of the red, green and blue light signals of a tri-linear CCD.

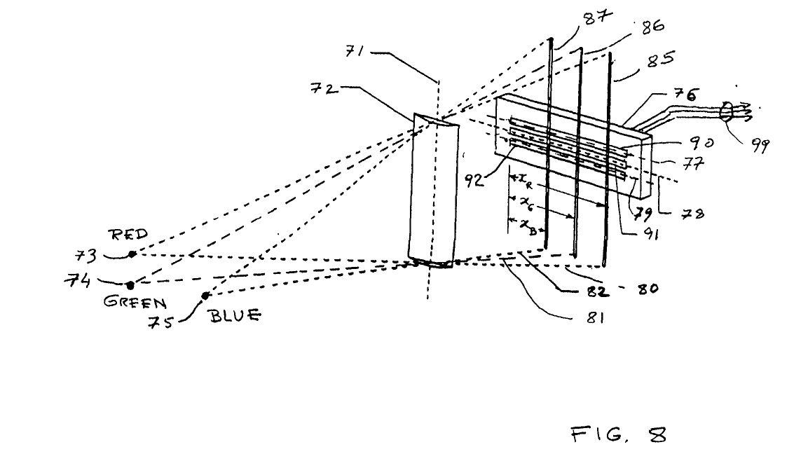

By replacing the linear CCD in a linear sensor with a tri-linear CCD, a multi-chromatic linear sensor, hereafter called a RGB linear sensor, in accordance with the present invention is obtained. FIG. 8 is a structural diagram of an exemplary RGB linear sensor in accordance with the present invention. Such an RGB linear sensor can determine the planes 80, 81, 82 passing through the lens axis 71 of a cylindrical lens 72 and targets 73, 74 and 75 radiating red, green and blue light, respectively. The cylindrical lens 72 forms line images 85, 86 and 87 of the targets on an image plane containing a tri-linear CCD sensor 76. The CCD 76 comprises elongated light sensitive regions 90, 91, and 92 along parallel longitudinal axes 77, 78 and 79, respectively, the axes being oriented perpendicularly to the lens axis. The light sensitive regions 90, 91, and 92 are provided with overlaying red, blue and green light filters, respectively, such that the light sensitive region 90, for example, responds only to image line 85 emanating from the red target 73, and similarly for the remaining two.

The tri-linear CCD 76 provides electrical signals 99 indicative of the positions Xᵣ, X_{g}, and X_{b} of the line images with respect to an origin on axis 78. The lens axis 71 and the positions of the line images define the planes containing the targets. Thus, the RGB linear sensor of the present invention can unambiguously determine which plane contains which of a triplet of red, green and blue targets.

Moreover, an assembly of two RGB linear sensors, mounted such that their lens axes are non-parallel, can unambiguously measure the direction to each target in a closely spaced cluster of red, green and blue targets.

Replacing the three linear sensors in a wide-field position sensor with three RGB linear sensors in a one-to-one correspondence of their lens axes results in an exemplary assembly, called a RGB wide-field position sensor, in accordance with the present invention. A RGB wide-field position sensor can unambiguously measure the positions of each target in a closely spaced cluster of red, green and blue targets. From position measurements of three non-collinear targets, orientation of axes affixed to a plane containing all the targets can be readily determined by vector analysis methods. If several such clusters are desired to be measured, the ambiguity in the data sets from each of the red, green and blue targets has to be resolved. In accordance with the invention, exemplary identification as described above provides a preferred solution.

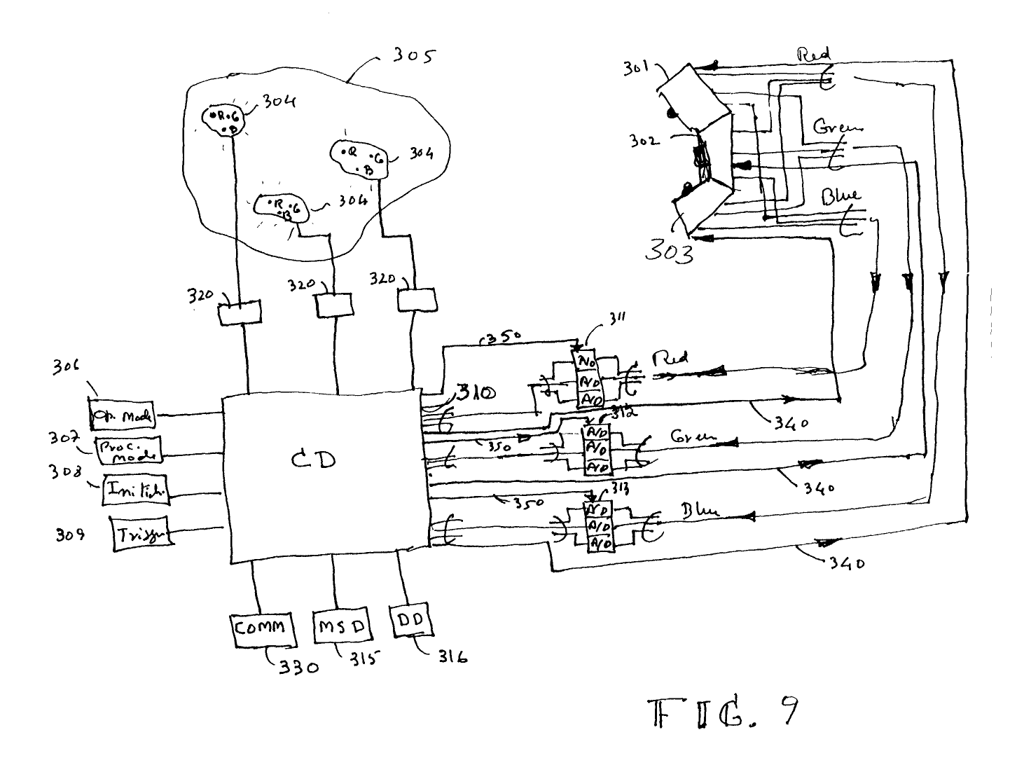

FIG. 9 is a structural diagram of an exemplary RGB wide-field position sensor in accordance with the present invention. A RGB wide-field position sensor 300 comprises three RGB linear sensors 301, 302, and 303. Target clusters 304, each comprising a red, green and blue target, are disposed at selected points of surface 305.

A computational device (CD) 310 comprises a processor architecture described as, but not limited to, a sequential instruction algorithmic machine or a microprocessor. Externally derived control signals for the CD 310 comprise an operational mode signal 306 for operating in either a slow-speed mode for applications in which only slow sampling rates are desired, or a high-speed mode for applications in which synchronous sampling of all targets is desired; a processing mode signal 307 for setting real-time or post processing of data; an initialization signal 308 for use when the high-speed mode is selected; and a trigger signal 309 for starting the measurement process.

The CD 310 provides a clock signal 340 to each of the RGB linear sensors to scan the light sensing area of its tri-linear CCD's and return a frame of video data for each of the red, green and blue colors. The CD 310 also provides a clock signal 350 to each of three sets of three A/D converters 311, 312 and 313 to acquire and digitize the analog video outputs of each of the three RGB linear sensors. The digital video outputs from the A/D converters, in turn, become inputs to the CD 310. The CD 310 also controls power-switching circuits 320 for the targets 304 such that each target clusters can be individually activated or deactivated.

If high-speed operation is set by the externally derived control signals, the CD 310 may also execute the process 200, shown in FIG. 7.

A mass storage device (MSD) 315, such as a random access memory (RAM) or magnetic or optical storage device or other memory device, records the raw data and real-time processed data as desired. A display device (DD) 316 shows a graphical or textual rendering of the raw CCD video frames from the RGB linear sensors, as well as 6-DOF position history of the targets. A communication port 330 enables uploading of data specific to the test, such as the number of targets, test duration after triggering, etc. to the CD 310, and downloading of test results to an external computer (not shown).

In a slow-speed mode of operation, when a trigger control signal 309 is received for commencing measurement, the CD 310 activates a first target cluster, and sends a clock signal to each of the RGB linear sensors to output video frames. A clock signal to the A/D converters enables digitization, and the digital video frames are then stored in the MSD 315. If real-time processing is desired, the 6-DOF positions of the target clusters are computed and stored in the MSD 315. The CD 310 repeats the process until all the remaining target clusters are similarly acquired. It then reactivates the first target and continues the process until the preset time duration for measurement has elapsed.

In a high-speed mode of operation, when an initialize control signal 308 is received, the CD 310 activates and deactivates each target cluster separately to establish the position of each target cluster image in the digital video frames of each RGB linear sensor for use in the subsequent algorithmic identification. Next, prior to commencing measurement, the CD 310 activates the target clusters. Then, when a trigger control signal 309 is received, the CD 310 sends a clock signal to each of the RGB linear sensors to output video frames.

A clock signal to the A/D converters enables digitization and the digital video frames are then stored in the MSD 315. If the processing mode control signal 307 is set for real-time processing, the CD 310 executes the process 200 in FIG. 7 for the identification, association and predictive tracking of the plurality of target cluster images. The CD 310 also computes the target cluster 6-DOF positions. The processed data is stored in the MSD 315. The CD 310 repeats the process until the preset time duration for measurement has elapsed. If the processing mode control signal is set for post processing, the CD 310 stores only the raw video frame data in the MSD 315. The data may then be processed at a convenient time by performing process 200.

Thus, a system is provided for measuring the three-dimensional positions of points, and orientation of axes affixed to those points, i.e., six degrees of freedom position measurements. For this purpose, tri-linear arrays of photosensitive elements, overlayed with red, green and blue filters, are used with a cylindrical optic system, to form a tri-linear sensor which is capable of simultaneously determining the directions to three targets, radiating red, green and blue light. Using three such tri-linear sensors, in place of the three linear sensors, a position measuring system is obtained that can determine the positions of closely spaced triads of red, green and blue targets. Using the position of the centroid of the triangle as the point of interest, six degrees of freedom measurement is accomplished by determining the orientation of axes affixed to a plane containing the triangle by way of vector analysis.

Accordingly, from the various embodiments described in the foregoing, the invention includes an optical position sensor capable of making accurate direction and position measurements of multiple optical targets that is economical to implement and adaptable to differing needs. More specifically, a non-contact position sensor has been described that is suitable for use in crash test dummies. Moreover, direction and position finding sensors are described that are capable of simultaneously measuring multiple targets at the sampling rate and resolution of the linear CCD's used. A non-contact 6-DOF position sensor has been described for closely clustered multiple targets.

It should be understood that the inventive principles described in this application are not limited to the components or configurations described in this application. It should be understood that the principles, concepts, systems, and methods shown in this application may be practiced with software programs written in various ways, or different equipment than is described in this application without departing from the principles of the invention.

The invention may be embodied in the form of appropriate computer software, or in the form of appropriate hardware or a combination of appropriate hardware and software without departing from the spirit and scope of the present invention. Further details regarding such hardware and/or software should be apparent to the relevant general public. Accordingly, further descriptions of such hardware and/or software herein are not believed to be necessary.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed is:

1. A position sensor for locating multiple radiating sources, comprising:
first, second and third linear sensors, each linear sensor comprising:
an optical device that focuses a source of radiation to form a line image parallel to a longitudinal optical axis of said optical device; and
an elongated light sensitive area positioned in a focal plane of said optical device for developing signals responsive to said radiation, said area comprising at least one linear array of photosensitive elements parallel to an axis that is aligned substantially orthogonal to said longitudinal optical axis of said optical device,
said first, second and third linear sensors each having said light sensitive area arranged in a plane, the axes of the light sensitive areas of said first and second sensors being aligned in a first direction and the axis of the light sensitive area of said third sensor being oriented in a second direction orthogonal to the first direction and disposed between said first and second linear sensors;
a computational device coupled to the linear sensors and adapted to
(a) turn radiation sources on and off;
(b) determine an image peak position of a radiation source in a video frame for each of a plurality of radiation sources and linear sensors;
(c) store image peak positions in a storage device;
(d) generate an association table for relating each of the plurality of radiation sources with their respective image peak positions;
(e) set a gate width for searching for a radiation source-associated-peak in a subsequent video frame, predicting an expected position value for the radiation source-associated-peak in the subsequent video frame, and searching for the radiation source-associated-peak in the subsequent video frame responsive to the gate width and the expected position; and
(f) determine positions of radiation sources;
a mass storage device coupled to the computational device to store data; and
a display device coupled to the computational device to display results.

2. The sensor according to claim 1, wherein each said light sensitive area comprises one array of photosensitive elements.

3. The sensor according to claim 1, wherein each said light sensitive area comprises:
a first array overlayed with a first optical filter for transmitting light in a first spectral band;
a second array overlayed with a second optical filter for transmitting light in a second spectral band; and
a third array overlayed with a third optical filter for transmitting light in a third spectral band such that the first, second and third arrays develop signals responsive to radiation emitted by sources radiating light in the first, second and third spectral bands, respectively.

4. A position sensor for locating multiple radiating sources, comprising:
first, second and third linear sensors, each linear sensor comprising:
an optical device that focuses a source of radiation to form a line image parallel to a longitudinal optical axis of said optical device, and
an elongated light sensitive area positioned in a focal plane of said optical device for developing signals responsive to said radiation, said area comprising at least one linear array of photosensitive elements parallel to an axis that is aligned substantially orthogonal to said longitudinal optical axis of said optical device;
a mounting structure comprising three adjoining non-coplanar vertical surfaces, a first surface disposed at a first angle and a second surface disposed at a second angle to a third surface between the first and second surfaces, the first surface carrying the first linear sensor, the second surface carrying the second linear sensor each with its longitudinal optical axis in a vertical plane, and third surface carrying the third linear sensor with its longitudinal optical axis in a horizontal plane, each linear sensor having its light sensitive area parallel to its associated mounting surface;
a computational device coupled to the linear sensors;
a mass storage device coupled to the computational device; and
a display device coupled to the computational device.

5. The sensor according to claim 4, wherein each said light sensitive area comprises one array of photosensitive elements.

6. The sensor according to claim 4, wherein each said light sensitive area comprises:
a first array overlayed with a first optical filter for transmitting light in a first spectral band;
a second array overlayed with a second optical filter for transmitting light in a second spectral band; and
a third array overlayed with a third optical filter for transmitting light in a third spectral band such that the first, second and third arrays develop signals responsive to radiation emitted by sources radiating light in the first, second and third spectral bands, respectively.

7. The sensor according to claim 4, wherein the first angle is substantially equal to the second angle.

8. The sensor according to claim 4, wherein the computational device is adapted to:
(a) turn radiation sources on and off;
(b) determine an image peak position of a radiation source in a video frame for each of a plurality of radiation sources and linear sensors;
(c) store image peak positions in said storage device;
(d) generate an association table for relating each of the plurality of radiation sources with their respective image peak positions;
(e) set a gate width for searching for a radiation source-associated-peak in a subsequent video frame, predicting an expected position value for the radiation source-associated-peak in the subsequent video frame, and searching for the radiation source-associated-peak in the subsequent video frame responsive to the gate width and the expected position; and
(f) determine positions of radiation sources.

9. The sensor according to claim 8, wherein the computational device is adapted to set the gate width equal to a distance of a nearest neighbor peak of the image peak position in the video frame.

10. A method of operating a position sensor in a slow mode, comprising:
for each of a plurality of radiation sources, in sequence
(a) turning on a radiation source;
(b) determining an image peak position of the radiation source in a video frame for each of a plurality of linear sensors;
(c) storing the image peak positions in a storage device;
(d) turning the radiation source off;
(e) generating an association table for relating each of the plurality of radiation sources with associated image peak positions;
(f) determining the radiation source positions based on the association table; and
(g) repeating steps (a) through (f) for a predetermined time duration.

11. A method of operating a position sensor in a fast mode, comprising:
for each of a plurality of radiation sources, in sequence
(a) turning on a radiation source;
(b) determining an image peak position of the radiation source in a video frame for each of a plurality of linear sensors;
(c) storing the image peak positions in a storage device; and
(d) turning the radiation source off;
generating an association table for relating each of the plurality of radiation sources with an associated image peak position; and
turning on all of the plurality of radiation sources.

12. The method according to claim 11, further comprising:
for each frame in sequence, and for each radiation source in sequence:
setting a gate width for searching for a radiation source-associated-peak in a subsequent video frame;
predicting an expected position value for the radiation source-associated-peak in the subsequent video frame;
searching for the radiation source-associated-peak in the subsequent video frame responsive to the gate width and the expected position;
storing the image peak positions in a storage device;
updating the association table;
repeating the radiation source sequence;
repeating the frame sequence; and
determining the positions.

13. The method according to claim 12, wherein setting the gate width comprises setting the gate width equal to a distance of a nearest neighbor peak of the image peak position in the video frame.

14. A crash test dummy comprising:
a wide-field position sensor attached to the crash test dummy; and
a plurality of optical targets disposed on the crash test dummy at respective locations for measurement by the wide-field position sensor.

15. The crash test dummy according to claim 14, wherein the position sensor comprises:
first, second and third linear sensors, each linear sensor comprising:
an optical device that focuses a source of radiation to form a line image parallel to a longitudinal optical axis of said optical device; and
an elongated light sensitive area positioned in a focal plane of said optical device for developing signals responsive to said radiation, said area comprising at least one linear array of photosensitive elements parallel to an axis that is aligned substantially orthogonal to said longitudinal optical axis of said optical device,
said first, second and third linear sensors each having said light sensitive area arranged in a plane, the axes of the light sensitive areas of said first and second sensors being aligned in a first direction and the axis of the light sensitive area of said third sensor being oriented in a second direction orthogonal to the first direction and disposed between said first and second linear sensors;
a computational device coupled to the linear sensors and adapted to
(a) turn radiation sources on and off;
(b) determine an image peak position of a radiation source in a video frame for each of a plurality of radiation sources and linear sensors;
(c) store image peak positions in a storage device;
(d) generate an association table for relating each of the plurality of radiation sources with their respective image peak positions;
(e) set a gate width for searching for a radiation source-associated-peak in a subsequent video frame, predicting an expected position value for the radiation source-associated-peak in the subsequent video frame, and searching for the radiation source-associated-peak in the subsequent video frame responsive to the gate width and the expected position; and
(f) determine positions of radiation sources;
a mass storage device coupled to the computational device to store data; and
a display device coupled to the computational device to display results.

16. The crash test dummy according to claim 15, wherein each said light sensitive area comprises one array of photosensitive elements.

17. The crash test dummy according to claim 15, wherein each said light sensitive area comprises:
a first array overlayed with a first optical filter for transmitting light in a first spectral band;
a second array overlayed with a second optical filter for transmitting light in a second spectral band; and
a third array overlayed with a third optical filter for transmitting light in a third spectral band such that the first, second and third arrays develop signals responsive to radiation emitted by sources radiating light in the first, second and third spectral bands, respectively.

18. The crash test dummy according to claim 14, wherein the position sensor comprises:
first, second and third linear sensors, each linear sensor comprising:
an optical device that focuses a source of radiation to form a line image parallel to a longitudinal optical axis of said optical device, and
an elongated light sensitive area positioned in a focal plane of said optical device for developing signals responsive to said radiation, said area comprising at least one linear array of photosensitive elements parallel to an axis that is aligned substantially orthogonal to said longitudinal optical axis of said optical device;
a mounting structure comprising three adjoining non-coplanar vertical surfaces, a first surface disposed at a first angle and a second surface disposed at a second angle to a third surface between the first and second surfaces, the first surface carrying the first linear sensor, the second surface carrying the second linear sensor each with its longitudinal optical axis in a vertical plane, and third surface carrying the third linear sensor with its longitudinal optical axis in a horizontal plane, each linear sensor having its light sensitive area parallel to its associated mounting surface;
a computational device coupled to the linear sensors;
a mass storage device coupled to the computational device; and
a display device coupled to the computational device.

19. A direction sensor for locating multiple radiating sources, comprising:
first and second linear sensors, each linear sensor comprising:
an optical device that focuses a source of radiation to form a line image parallel to a longitudinal optical axis of said optical device; and
an elongated light sensitive area positioned in a focal plane of said optical device for developing signals responsive to said radiation, said area comprising at least one linear array of photosensitive elements parallel to an axis that is aligned substantially orthogonal to said longitudinal optical axis of said optical device,
said first and second linear sensors each having said light sensitive area arranged in a plane, the axes of the light sensitive areas of said first sensor being aligned in a first direction and the axis of the light sensitive area of said second sensor being oriented in a second direction orthogonal to the first direction;
a computational device coupled to the linear sensors and adapted to
(a) turn radiation sources on and off;
(b) determine an image peak position of a radiation source in a video frame for each of a plurality of radiation sources and linear sensors;
(c) store image peak positions in a storage device;
(d) generate an association table for relating each of the plurality of radiation sources with their respective image peak positions;
(e) set a gate width for searching for a radiation source-associated-peak in a subsequent video frame, predicting an expected position value for the radiation source-associated-peak in the subsequent video frame, and searching for the radiation source-associated-peak in the subsequent video frame responsive to the gate width and the expected position; and
(f) determine directions of radiation sources;
a mass storage device coupled to the computational device to store data; and
a display device coupled to the computational device to display results.

20. The sensor according to claim 19, wherein each said light sensitive area comprises one array of photosensitive elements.

21. The sensor according to claim 19, wherein each said light sensitive area comprises:
a first array overlayed with a first optical filter for transmitting light in a first spectral band;
a second array overlayed with a second optical filter for transmitting light in a second spectral band; and
a third array overlayed with a third optical filter for transmitting light in a third spectral band such that the first, second and third arrays develop signals responsive to radiation emitted by sources radiating light in the first, second and third spectral bands, respectively.

22. The sensor according to claim 21, wherein the first spectral band is red, the second spectral band is green and the third spectral band is blue.
